(19) United States
(12) Patent Application Publication
(10) Pub. No.: US 2010/0187183 A1
(43) Pub. Date: Jul. 29, 2010

(54) COMBINATION PERSONAL WATER BOTTLE FILTER AND FLUID PUMP

(76) Inventors: Steven D. Nelson, Buena Park, CA (US); Leona I. Nelson, Buena Park, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 12/359,135

(22) Filed: Jan. 23, 2009

(51) Int. Cl. B01D 35/30; B65D 23/00; B01D 37/00; B01D 29/11

(52) U.S. Cl. 210/741; 215/386; 210/136; 210/767; 210/241; 210/232

(57) ABSTRACT

the chamber including a filter for filtering fluid from a pump to the container and a check valve to check flow of water from the container to the pump housing.

### BACKGROUND

1. Field of the Invention

The present invention relates to personal water bottles sometimes referred to as sports bottles.

2. Description of the Prior Art

The health and well being of society is dependent on healthy diets and vigorous exercise. Rehydration is critical to the well being of the performance of the athletes, whether competitive or casual. Athletes involved in exercise and workouts benefit from ready access to fluids during their exercise or other competitive activity. This fact has lead to the development of individual water bottles known as sports bottles. The popularity of individual water bottles has lead to a significant threat to the environment from the disposal of one-use bottles which are often manufactured from non-biodegradable plastics.

Both individual taste and concerns over unhealthy contaminants in tap water have popularized the use of filtered bottle water to satisfy needs of the consumer. Numerous different efforts have been made to provide for economic and efficient filtering of tap water to provide palatable drinking water.

These demands in the marketplace have led to numerous different proposals for individual bottle devices which incorporate various forms of filters for filtering tap water contained in the bottles and dispensed from the bottle.

As recognized in the Nov. 6, 2008 article “Water Bottles Outfitted With Filters” in the Wall Street Journal, water bottles were originally used for hiking and other outdoor activities and are now being outfitted with their own filters and marketed with appeal to Eco-Conscious and frugal consumers who want to avoid buying bottled water and appreciate the convenience of being able to fill up on the go. As is noted in that article, many of the products on the market involve squeezing the bottles to push water through the filters but squeezing of the bottle can prove somewhat challenging and sometimes lead to fatigue of the bottle walls.

Examples of the prior bottles are those configured with a neck mounting a micro filtering membrane permeable to liquid but impermeable to air when wet. A device of this type is shown in U.S. Pat. No. 5,310,085 to Lontrade et al. While providing for some filtering effect, devices of this type suffer the short coming that the flow rate produced by compression of the container walls is often rather modest thus limiting the rate at which the much needed fluid is dispensed.

Other individual bottles have been proposed for connection directly with a faucet and which incorporate a filter in the neck area through which water is forced upon compression of the container side walls to provide filtered water. A device of this type is shown in U.S. Pat. No. 5,362,385 to Klegreman.

Other efforts have led to a proposal for an apparatus including first and second chambers for receiving filtered and unfiltered water and including a pressurizing pump for pressurizing the unfiltered chamber to drive water through a filter into a cup for drinking. A device of this type is shown in U.S. Pat. No. 4,477,347 to Sylva.

Other proposals have included a water bottle including a piston pump exterior of the bottle for pressurizing the bottle to force water through a treatment cartridge. A device of this type is shown in U.S. Pat. No. 4,054,526 to Muller.

Another example is a water container to be pressurized by an air pump to drive water from the container through a filter into a drinking cup. A device of this type is shown in U.S. Pat. No. 4,477,347 to Sylva.

Other bottle designs have also relied on an air pressurization pump to force water through a filtration system and out a drinking outlet. An example of such a device is marketed by LifeSaverSystems.com, Old Bakery, 7 Tuddenham Avenue, lpswichIP42HE, United Kingdom. Bottles of this type require significant interior volume for the pump and suffer the shortcoming that the water exiting the container passes through the filter thus limiting the extent to which additives, such as flavoring and energy supplements may be added to the water without clogging the filter.

As can be seen, prior portable filtration bottles and containers and have involved a trade-off between bulkiness, convenience and effectiveness. An example of one of these bulky system is a water container having a piston or other pump device contained therein and biased to a pressurizing position by a coil spring so that the piston could drive water through a filter to be filtered through a carbon or charcoal filter. A device of this type is shown in U.S. Pat. No. 4,054,526 to Muller.

### SUMMARY OF THE INVENTION

The present invention is characterized by a fluid pump to draw fluid from a container for filtration and return to the container.

### BRIEF DESCRIPTION OF THE DRAWINGS

FIG. 1 is a perspective view of a combination fluid container and fluid pump embodying the present invention;

FIG. 2 is a exploded view of the container shown in FIG. 1;

FIG. 3 is a bottom view of the container shown in FIG. 1;

FIG. 4 is a partial vertical sectional view, in enlarged scale, taken along the line 4-4 of FIG. 2;

FIG. 5 is a transverse sectional view taken along the line 5-5 of FIG. 4;

FIG. 6 is a transverse sectional view taken along the line 6-6 of FIG. 4;

FIG. 7 is a partial vertical sectional view, in enlarged scale, taken along the line 7-7 of FIG. 1;

FIGS. 8 and 9 are partial vertical sectional views similar to FIG. 7 but showing the pump and container in different operational modes;

FIGS. 10, 11, 12 and 13 are partial side views taken along the line 10-10 of FIG. 5 and showing the combination fluid pump and bottle in different operational positions; and

FIG. 14 is a perspective view of a second preferred embodiment of the combination of container and pump of the present invention;

FIG. 15 is a perspective view similar to FIG. 14 but exploded;

FIG. 16 is a bottom view of the container and pump shown in FIG. 14;

FIG. 17 is a transverse sectional view, in enlarged scale taken along the lines 17-17 of FIG. 15;

FIG. 18 is a transverse sectional view, in enlarged scale, taken along the line 18-18 of FIG. 15;

FIG. 19 is a vertical sectional view, in enlarged scale, taken along the line 19-19 of FIG. 14;

FIG. 20 is a partial vertical sectional view, in enlarged scale, taken along the line 20-20 of FIG. 19;

FIG. 21 is a transverse sectional view taken along the line 21-21 of FIG. 20; and

FIG. 22 is a vertical sectional view similar to FIG. 19 but depicting the top operative to fill the container with filtered water.

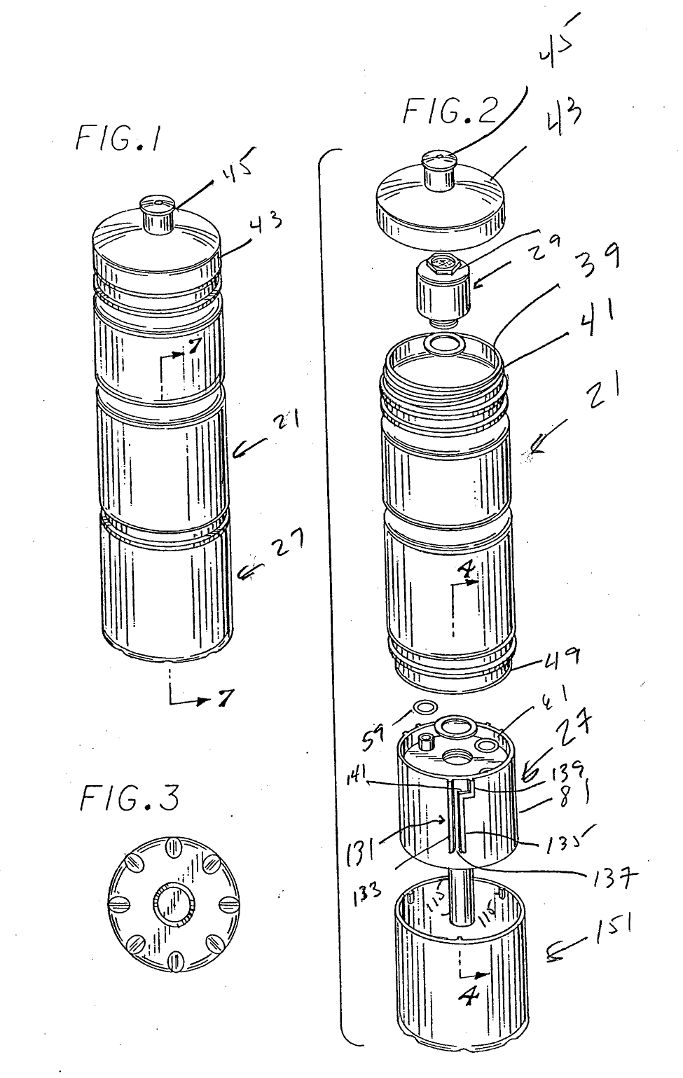

### DETAILED DESCRIPTION OF THE PREFERRED EMBODIMENTS

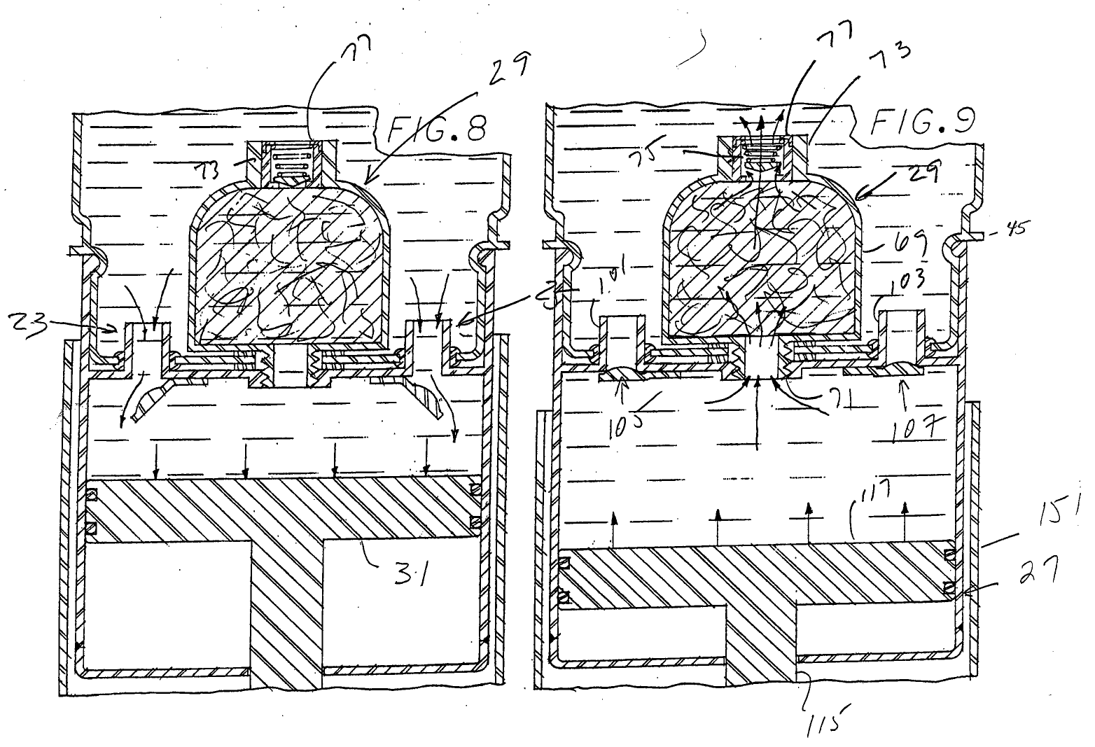

Referring to FIGS. 2, 8 and 9 an exemplary embodiment of the water pump and filtration bottle of the present invention includes, generally, a water container 21 configured in its bottom wall with valved outlet devices 23 and 25 for flowing water into a water pump, generally designated 27, to be flowed under pressure back into the container through a valved filter device, generally designated 29. In this exemplary embodiment, the pump device 27 includes a piston 31 which may be drawn downwardly to draw water from the container 21 as shown in FIG. 8 and then pressed upwardly to drive water through the filter and back into the container as shown in FIG. 9.

The fluid container 21 is conveniently constructed with a volume to hold about 23 ounces of fluid corresponding with the volume typically associated with a single dosage for nutritional flavoring, and juice mixes. The container is configured with a height of approximately 5¼″ inches and a diameter about 3″ inches to form at its upper extremity a mouth 89 of a diameter for conveniently receiving full size ice cubes and the like from ice cube dispensers. The upper extremity is externally threaded at 41 for receipt of a downwardly opening cup shaped cover 43 formed centrally with an upraised spout covered by a valve actuating cap 45.

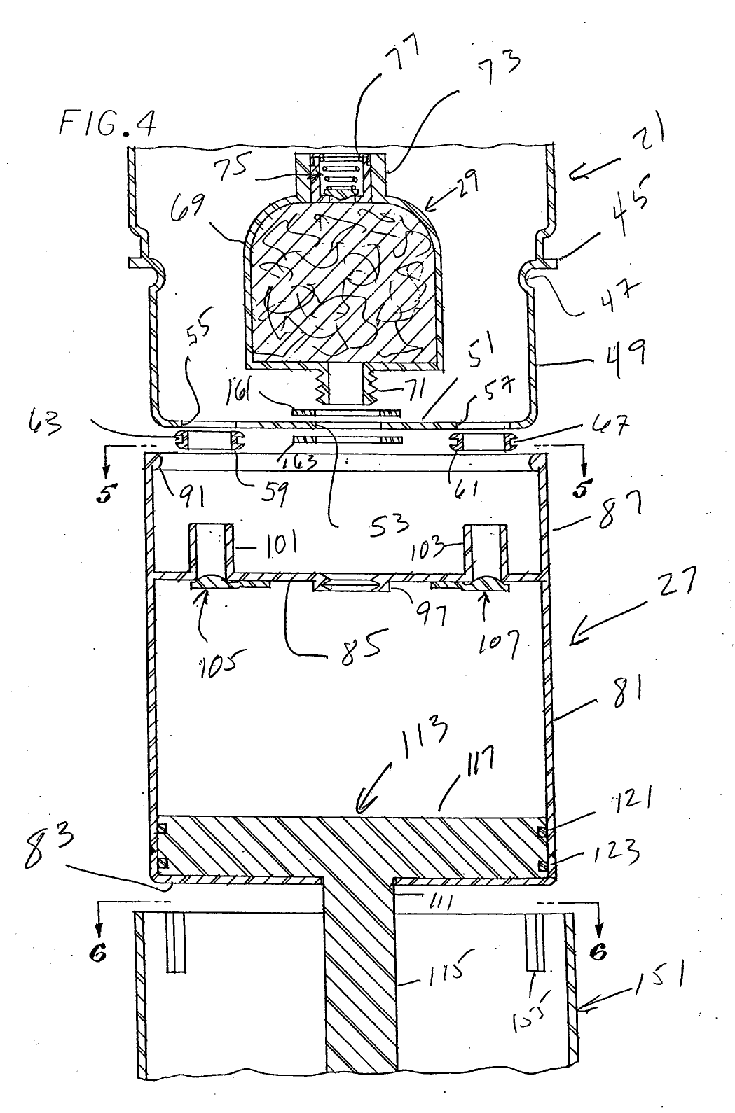

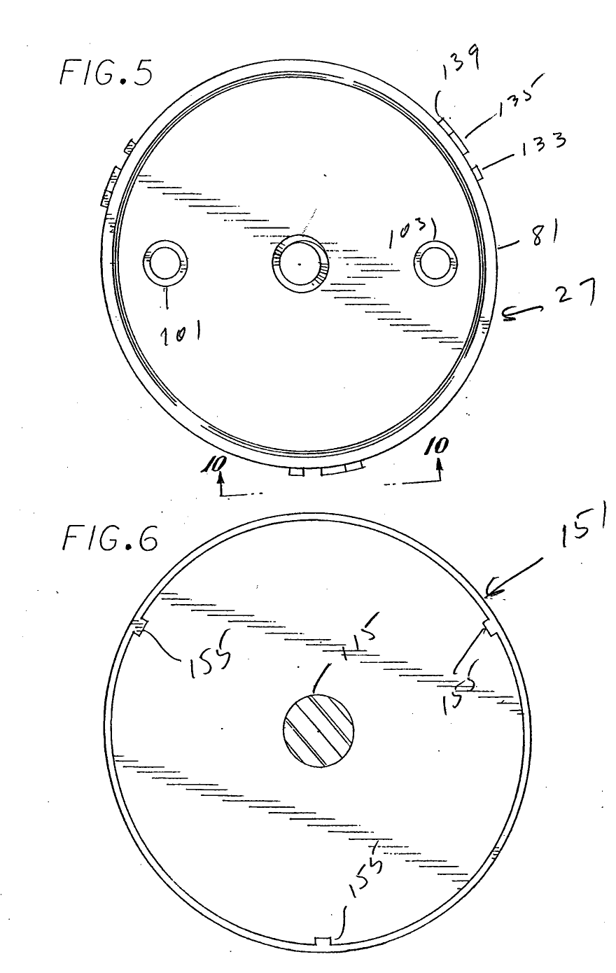

Referring to FIG. 4, the exterior container 21 is configured in its lower extremity with a stepped down diameter to form a radially outwardly projecting annular flange 45 and is then undercut below the flange to form a radially outwardly opening annular locking groove 47 and then projects downwardly to form a reduced in diameter neck 49. The neck 49 is closed at its bottom extremity by a bottom wall 51. In this embodiment, the bottom wall 51 is formed centrally with a through inlet bore 53 having a pair of smaller outlet bores 55 and 57 spaced radially there from on the diametrical opposite sides thereof Received in the respective outlet bores 55 and 57 are respective grommets 59 and 61 formed with outwardly opening annular grooves 63 and 67 respectively, for complementally fitting about the marginal edges of the respective bores 55 and 57.

The filter device 29 includes a jar shaped peripheral cylindrical housing 69 and is formed at its lower extremity with a threaded stud 71 for receipt through the bore 53. The upper extremity of the housing 69 is formed with an upstanding nipple 73 which receives a spring loaded relief valve, generally designated 75, operable to provide a slight back pressure against upward flow of fluid and configured to release at approximately 1 psi to release flow through an upwardly opening nozzle 77 formed by the nipple 73.

The pump 27 is formed with a cylindrical housing 81 including a bottom wall 83 and formed medially along the length thereof with a transverse communication wall 85. A shroud 87 projects upwardly from the communication wall 85 to telescope over the neck and is formed in its upward extremity with a radially inturned bead 91 configured to be snap fit into the groove 47.

The communication wall 85 is formed centrally with a vertical interiorly threaded, through, tube segment 97 for complemental receipt of the exteriorly threaded lug 71 of the filter.

The wall 85 is formed on the diametrical opposite sides of the stub 97 with a pair of upstanding nipples 101 and 103 configured to be press fit into sealing engagement with the interior of the respective grommets 59 and 61. In the exemplary embodiment, one way flapper valves 105 and 107 are mounted on the under side of the wall 85 for receiving downwardly flow through the respective nipples 101 and 103 but biased against flow upwardly through such nipples.

The bottom wall 83 is formed centrally with a through bore 111. A piston, generally designated 113, is received slidably within the pump housing and is configured with a downwardly projecting piston stem 115 received in the bore 111. The piston includes a cylindrical plate 117 configured in its periphery with respective O-ring glands receiving O-rings 121 and 123 held in sealing engagement with the interior wall 81.

Referring to FIGS. 2 and 10, the exterior of the peripheral wall 81 is configured with axially extending key ways, generally designated 131, spaced equidistance about the periphery and each formed with a pair of axially extending, annularly spaced apart longitudinal ribs 133 and 135 to form therebetween respective longitudinal tracks 137. With continued reference to FIGS. 2 and 10, the ribs 135 are configured at their upper extremities with respective lateral offsets 139 to form respective upwardly facing shoulders 141.

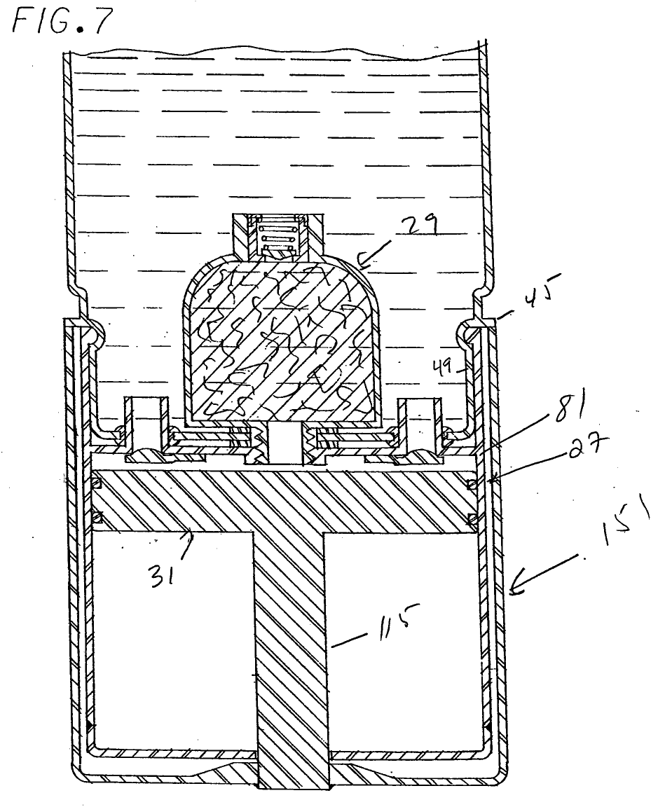

Referring to FIGS. 2 and 7, an upwardly opening, cup-shaped actuator, generally designated 151, is telescopically received about the pump housing 81 and is carried on its bottom wall from the stem 115 to thus provide a convenient hand actuated actuator for the pump.

Referring to FIGS. 6, 12 and 13, the cylindrical wall of the actuator 151 is formed interiorly with three equispaced lugs defining respective followers 155 arranged about the peripheral wall to be slidably received in the respective grooves 137. The followers are configured and disposed so as to be, when in the piston is driven to its full upward position, disposed in horizontal alignment with respective offset ribs 139 so that their lower edges will be engaged with the respective upwardly facing shoulders 141 when the actuator cup 151 is rotated counterclockwise (FIG. 2) from the position shown in FIG. 2 for the position shown in FIG. 13.

The various housings for the container 21, pump 27 and actuator 151, as well as the cover 43 are preferably constructed of biodegradable plastic as is well known in the art. The term biodegradable plastics as used in this disclosure are those plastics which will decompose in the natural environment. Biodegradation of plastics can be achieved by enabling micro-organisms in the environment to metabolize the molecular structure of the plastic films to produce an inert humus-like material that is as harmful to the environment. They may be composed of either bioplastics, which are plastics whose components are derived from renewable raw materials or petroleum-based plastics. The use of bio-active compounds compounded with swelling agents ensures that, when combined with heat and moisture, they expand the plastics molecular structure and allow the bio-active compounds to metabolize neutralize the plastic.

In operation, it will be appreciated, the filter 29 is replaceable but will typically be installed in the fluid container 21 by, for instance, a tool accessible through the open mouth 39 to engage the hexagonal external configuration of the spout 73.

The filter 29 itself is preferably a level 5 filter and may be an ionic absorption micron filter, such as a uniform 2-micron pore size designed for removal of offensive odors, pathogens and dissolves solids available from Seychell Environmental Technologies, Inc., www.seychell.com or www.purelyfiltered.com.

The filter may be conveniently installed by inserting the filter nipple 71 through the bore 53 (FIG. 4) and through a pair of annular seals 161 and 163 sandwiching the marginal edge of the bore, to thus screw into the stub 97 in the communication wall 85.

The pump 27 may be secured to the bottom of the container 21 by sliding the cowling 87 up over the neck 49 (FIG. 4) to engage the rib 91 with the groove 47 to positively hold the pump in place. It will be appreciated that in so doing, the nipples 101 and 103 will be received through the respective grommets 59 and 61 to be held sealingly in place, all with the stub 97 aligned vertically beneath the bore 53.

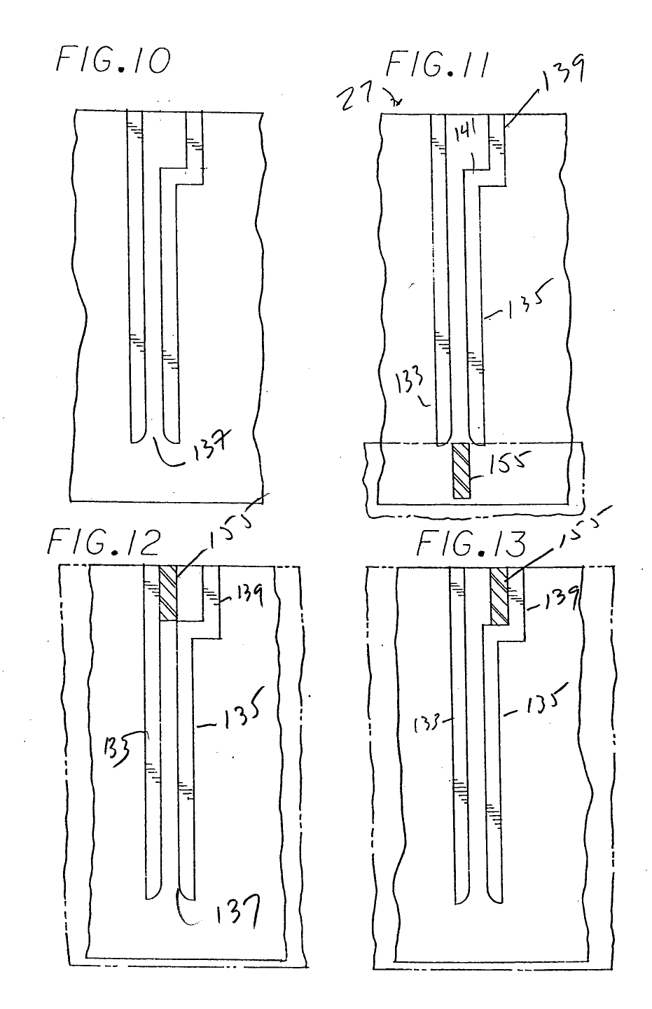

When the user then elects to utilize the bottle device and filtration system, he or she may fill the container 21 by removing the cover 43 and introducing water or other fluid through the mouth 39 and possibly even adding ice cubes. This bottle device may be transported as by a bicycle or in a backpack or sling to thus be readily available for drinking. When the tap water is to be filtered, the user may conveniently actuate the pump 27 by grasping the actuator 151 (FIG. 7) and rotating it counterclockwise to disengage the respective followers 155 from alignment over the shoulders to alignment with the track 137 as shown in FIG. 12 so that the user may draw the actuator downwardly on the pump housing thus drawing the piston 31 downwardly as shown in FIG. 8 thereby generating a negative pressure over the piston plate to thus open the respective flapper valves 105 and 107 thereby drawing water into the piston chamber beneath the communication wall 185. In the preferred embodiment, the pump is configured with a volume to displace approximately 5 ounces with each stroke to thereby provide for displacement of substantially the entire volume of the beverage container 21 with four strokes. As a practical matter, it is recommended that the piston be pumped five time to be sure that all unfiltered water has been displaced to thereby provide substantially fully filtered water in the upper elevations of the container 27.

In this regard in order to gain full benefit of this embodiment of the present invention, it is recommended that the container be held somewhat erect during the pumping and drinking function as the filtered water pump back into the container will tend to rise to the top of the body of water within the container with the unfiltered water tending to migrate to the bottom of the column of contained water.

It will be appreciated that, as the pump is reciprocated, during the upward stroke shown in FIG. 9, the water which was extracted from the container during the downward stroke will be driven upwardly through the nipple 97 through the filter 29 to press upwardly on the pressure relief valve 75. When the pressure exceeds about 1 psi, the valve will open thus providing for communication through the nozzle 77 opening upwardly in the container. The pump 27 is constructed such with relatively convenient manual operation a pressure from 8 to 10 psi can readily be generated thus providing for a pressurized stream to be ejected from the nozzle 77 upwardly into the body of water within the container 21 to thereby tend to drive the newly filtered water to the upper elevations within such container thereby tending to maintain laminations between the filtered and unfiltered water tending to settle towards the bottom of the container. It is a benefit of the present invention that the construction takes advantage of this tendency of filtered and unfiltered water to laminate whereby, in this combination, the filtered water will tend to be located proximate the cover 43 and the outlet nipple into the cap 45.

As will be appreciated by those skilled in the art, once the volume of tap water in the container 21 has been fully displaced as by five reciprocations of the pump, additives such as nutrients, flavoring fruit supplements may be introduced through the mouth 39 of such container and will be mixed with the filtered water for ready ingestion by the user without any need for the additive to be passed through the media filter 39.

Once the volume of filtered water in the container 21 has been consumed, the user may readily access a tap or fountain to refill the container 21 to ready it for use by again pumping the tap water to the pump 27 and filter 29 as described above thus providing for convenient reuse.

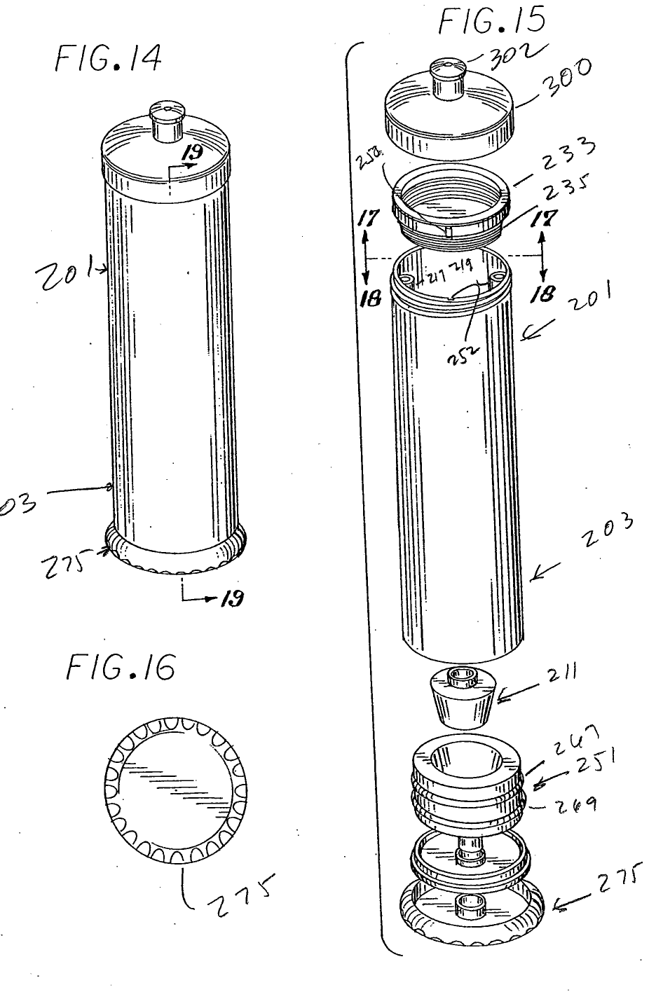

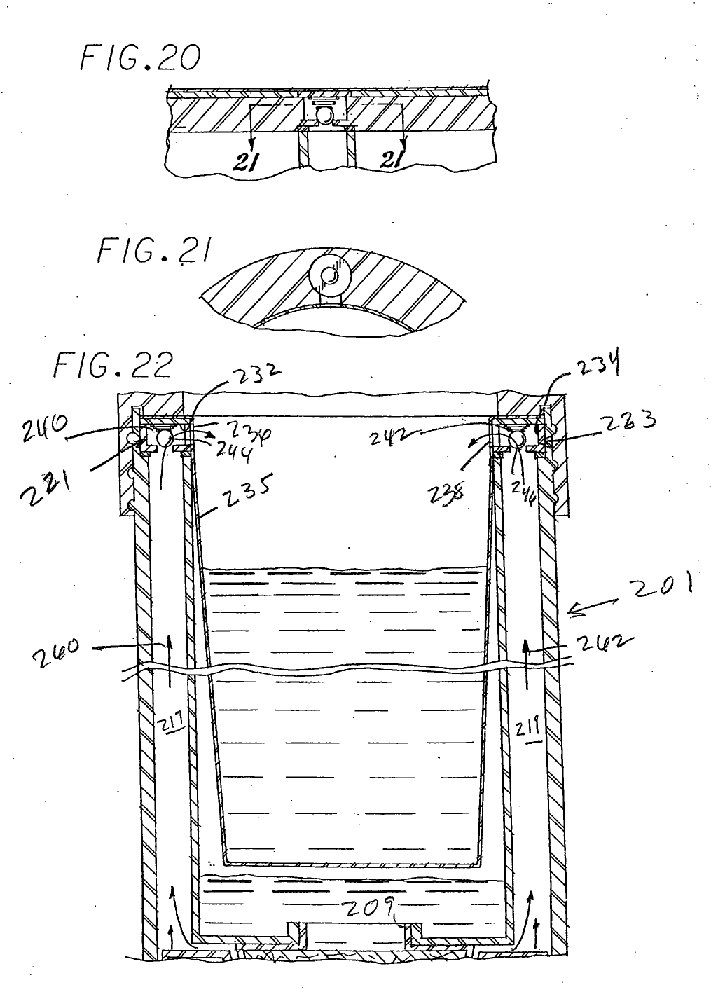

Referring to FIG. 14-22, a preferred embodiment of the personal bottle apparatus of the present invention includes cylindrical container 201 and pump housing 203 which may be of integral construction and separated by a transverse communication wall 205 which is formed centrally with an outlet opening 209 having a frusto conical media filter, generally designated 211, mounted therebelow. Mounted to the bottom of the filter device 211 is a one-way check valve 210 which opens downwardly to form a through filtration fluid path through the filter from the outlet opening 209. In some embodiments, the peripheral wall of the container 201 is transparent or translucent for convenient viewing of the interior. In other modifications the pump housing is releasably coupled to the container.

Formed at the diametrical opposite sides of the communication wall 205 are a pair of inlet ports 213 and 215 surmounted by respective stand pipes 217 and 219 defining inlet tubes confronted at their respective upper extremities with one way valves 221 to 223 which respond to pressure to flow fluid upwardly and outwardly there through (FIG. 22).

In some embodiments, the apparatus incorporates an elongated pleated bag device, generally designated 231, carried on an annular rim 233 for nesting on the top edge of the peripheral wall of the container and supporting a flexible pleated bag 235 which may distend downwardly into the container so it is in fluid communication at the upper extremity with flow from the respective valves 221 and 223.

The rim 233 is configured to be telescoped downwardly into the open top of the container 201 and is formed on its diametrical opposite sides with respective valve chambers 232 and 234 disposed in vertical alignment over the respective stand pipes and configured with respective stand pipes and configured with respective radially inwardly opening outlets 234 and 238. Compression coil springs 240 and 242 presses respective check balls 244 and 246 downwardly with sealing engagement with respective valve seats. The rim is formed in its opposite sides with radially outwardly projecting ears 250 for selective sliding receipt in outwardly spring, including inwardly opening index notches 252 (FIGS. 15, 17 and 18). It is noted that in some embodiments the valves 221 and 223 are incorporated in the stand pipes themselves. It will be understood that the spatial relationship between the filter 211 and one more inlet valves may take many different configurations, it only being important that the unfiltered water drain from the pump housing 203 be passed through the filter before being flowed back into the bag 235.

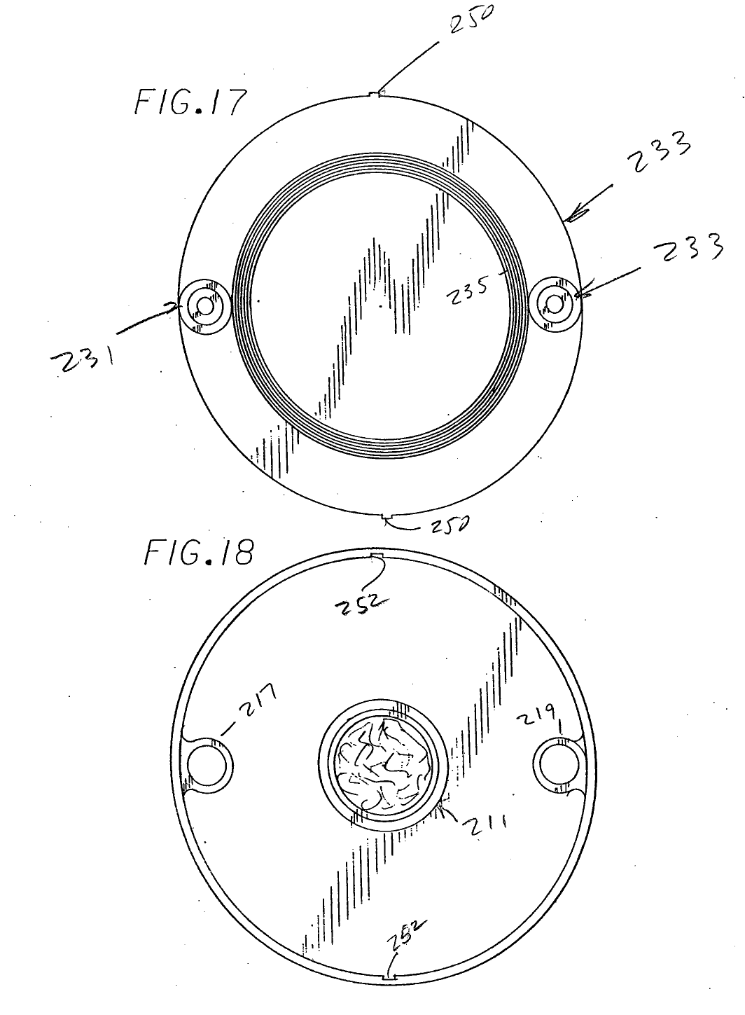

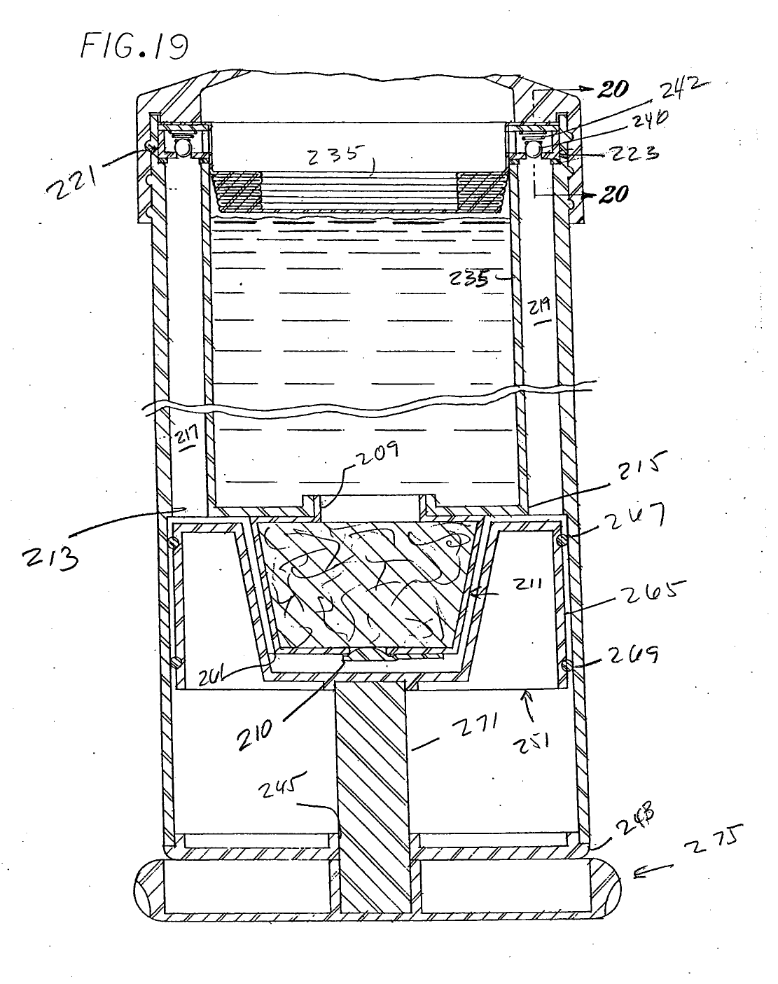

Referring to FIG. 16 in the exemplary embodiment, the pump housing 203 is formed with an interior chamber 241 surrounding the central frusto conical filter device 211 configured with a bottom wall 243 formed centrally with a stem bore 245. Received telescopically within the pump chamber 241 is a piston, generally designated 251, in the form of a plastic sheet formed to define a central, upwardly opening frusto conical cavity 261 opening upwardly and disposed in vertical alignment with the filter 211 for complemental fit thereover. The formed sheet then flares radially outwardly at the upper extremity of the cavity 261 and then turns downwardly to form an annular skirt 265 mounting a pair of O-rings 267 and 269 (FIG. 19) in the exterior thereof for sealing engagement with the interior wall of the pump chamber 241.

Depending downwardly from the piston is a centrally disposed axial drive rod 271 mounting at its lower extremity a circular actuator plate defining an actuator handle generally designated 275.

In operation, when a user is to fill the apparatus of FIGS. 14-22, the cover 300 of the container may be removed and the divider bag 231 removed so that tap water may be utilized to fill the interior of the container 201. The divider bag 231 may be then positioned in place with the rim 233 indexed by the ears and notches 250 and 252 to align the respective valves 221 and 223 over the top ends of the respective pipes 217 and 219.

The cover may then be reattached and a user may grasp the handle 275 and reciprocate the piston 251 to alternately generate a negative pressure within the pump chamber 241 to draw filtered water through the outlet 209 to be filtered through the filter and collected in the pump chamber 241. Upon stroking the piston upwardly, a positive pressure will be generated in the chamber 241 thus closing the valve 210 and driving the filtered water up the respective stand pipes 217 and 219 to open the respective valves 221 and 223 in the direction of the directional arrows 260 and 262 to pass the filtered water over through the respective outlets 236 and 238 (FIG. 22) to flow it downwardly into the interior of the pleaded bag 235 thus extending the bag axially downwardly with the container as the filtered water therein displaces the unfiltered water being drawn downwardly through the outlet 209 and into the pump chamber 241. This reciprocation of the piston will be repeated four times to replace the entire volume of the 23 ounces of water contained in the container thereby providing fresh filtered water within the pleated bag 235 so that upon opening of the container cover or cap the filtered water will be available to the user for consumption. If desirable energy or flavoring additives may be added to the bag to enhance the functioning of the water drawn therefrom through, for instance, a nipple 302 on the cover 300. It will be appreciated that as the filtered water is withdrawn from the bag 235, the bag will be collapsed upwardly within the container 201 until the entire volume of filtered water is consumed.

Consequently, it can be seen that the device of the present invention provides for convenient filtration to enable use of relatively inexpensive tap water or even stream water without the expense of purchasing bottled water in individual bottles and the like which can prove relatively expensive and, for one use bottles discarded after a single use, contributing immensely to the environment withdrawing from the flow of plastics to landfills and the like. These embodiments of the filtering bottle device of the present invention are adaptable for numerous reuse before replacement of the filter devices 29 and 211 is required and even more extensive reuse during the life of the particular container, possibly up to over 100 refills.

From the foregoing, it will be appreciated that the fluid pump and filtering bottle device of the present invention provides for effective and convenient filtration of drinking fluids with numerous reuses.

We claim:

1. A personal water bottle device comprising:
a water container including an outlet on the upper extremity and formed with a container chamber having bottom wall on the lower extremity;
a liquid pump housing connected to the bottom extremity of the container, formed with a pump chamber and including a pump for alternately creating a positive pressure and a negative pressure in the pump chamber;
a filter device for communicating water between the chambers and operative in response to the positive pressure to flow filtered water to one of the chambers.
at least one flow tube leading from the one chamber to the other chamber and including a check valve responsive to the positive pressure to block flow form the other chamber to the one chamber.

2. The personal bottle device of claim 1 wherein:
the filter includes a pressure control valve responsive to a predetermined pressure to open and flow water into the one chamber.

3. The personal bottle device of claim 1 wherein:
the filter is a media filter.

4. The personal bottle device of claim 1 wherein:
the container is constructed of biodegradable material.

5. The personal bottle device of claim 1 that includes:
a coupling for releasably coupling the pump housing to the container.

6. The personal bottle device of claim 1 wherein;
the container is constructed with the one chamber at least 5″ inches high;
the filter device is constructed with an upwardly facing outlet port of a predetermined cross section opening into the one chamber; and
the pump is constructed to, when pumped at a selected rate, generate a sufficient rate of fluid flow through the port to flow a stream of the liquid upwardly in the one chamber a distance of at least 5″ inches.

7. The personal bottle device of claim 1 wherein:
the pump is a piston pump constructed with a selected stroke to, when reciprocated, pump a predetermined volume of the liquid through the filter device; and
the container is constructed with the one chamber having a capacity of at least 4 times the predetermined volume.

8. The personal bottle device of claim 7 wherein:
the predetermined volume is sufficient to hold 5 ounces of water.

9. The personal bottle device of claim 1 wherein:
the pump includes a reciprocal piston and a downwardly projecting piston stem and wherein the bottle apparatus includes an actuator handle in the form of a cup connected to the stem and slidably received over the pump housing to be grasped by the operator and reciprocated back and forth to reciprocate the piston.

10. The personal bottle device of claim 9 wherein;
the actuator is formed on its interior wall with at least one follower; and
the pump housing is formed on its exterior wall with at least one longitudinal race slidably receiving the follower and cooperating therewith to maintain alignment between the actuator and pump housing.

11. The personal bottle device of claim 10 wherein:
the actuator is rotatable on the pump housing; and
the pump housing is configured at the upper end of the race with a lateral stop segment projecting in one lateral direction from the longitudinal axis of the race and constructed for receipt of the follower whereby the actuator may be slid upwardly into a retracted position on the pump housing and rotated in the one lateral direction of dispose the follower in the segment to lock the follower in the retracted position.

12. The personal bottle of claim 1 wherein:
the container is formed to be held erect and to define the one chamber to be, when the container is erect, elongated in the vertical direction; and
the filter is arrayed to flow filtered fluid into the chamber from the bottom of the container.

13. A personal water bottle comprising:
a cylindrical container including a outlet in its upper portion and a lower portion configured with a peripheral radially outwardly opening annular snap groove and including a bottom wall formed with a through bore and a pair of inlet openings;
a pump device including a cylindrical housing configured with a pump chamber and formed in its upper extremity with a communication wall and a cowling configured with a radially inturned container ring snap fit into the groove, the connector wall including a threaded bore aligned with the through bore and nipples projecting through the respective inlet openings and including one wave valves to control flow through the inlet openings, the pump further including a piston pump reciprocal to generate a predetermined pressure in the pump chamber and to pressurize the filter; and
a media filter apparatus in the container chamber including a threaded stud projecting through the through bore and secured into the threaded bore, the filter device further including in its upper portion a pressure relief valve responsive to this predetermined pressure to open a upwardly opening port to direct a stream of liquid substantially five inches high within the container;
a cup shaped actuator received slidably over the pump housing and coupled with the piston to be grasped manually to reciprocate the piston with a sufficient force to generate the predetermined pressure.

14. A method of filtering water in a personal water bottle including:
selecting a portable liquid container;
selecting a liquid filter;
selecting a liquid pump;
actuating the pump to draw the unfiltered liquid from the container to flow it through the filter and return it to the container.

15. A method of claim 14 that includes:
releasably attaching the pump to the container.

16. The method of claim 14 that includes:
selecting the filter as a media filter.

17. The method of claim 13 that includes:
the step of selecting a nozzle to control outlet flow from the filter and pressurizing the filter to the point where the nozzle generates a spout of liquid upwardly in the container.

18. A personal fluid bottle device comprising:
a personal liquid container device formed with a container chamber;
a fluid pump device connected to the container and formed with a pump chamber and including a liquid pump for alternately creating a positive pressure and a negative pressure in the pump chamber;
an inlet check valve in one of the devices to controlling flow in one direction from one of the chambers to the other of the chambers; and
a filter device mounted to one of the devices to filter and communicate the liquid in a direction opposite the one direction from the other of the chambers to the one of the chambers.

19. The personal fluid bottle device of claim 18 wherein:
the container device includes a filtered liquid inlet;
the filter device is mounted to the pump device and includes a nipple connected to the filtered liquid inlet.

20. The personal fluid bottle device of claim 18 that includes:
a sealing grommet in the inlet and wherein when the top wall includes an outlet nipple sealingly engaged in the grommet.

21. The personal fluid bottle device of claim 18 wherein:
the pump device includes a top wall configured with an internally threaded filter bore; and
the filter includes a housing formed with a downwardly projecting threaded stem screwably received in the threaded bore.

22. The personal fluid bottle device of claim 19 and the wherein:
the container is elongated and includes a communication wall separating the pump chamber and container and includes at least one inlet tube leading from the pump chamber to the opposite end of the container and terminating in an open end; and
a ring mounting a collapsible bag for receipt in the container and the ring including a of check valve for permitting liquid flow under pressure from the pump chamber to the container and blocking flow in the reverse direction.

23. The personal fluid bottle device of claim 22 wherein:
the rim mounts a collapsible bag for receiving liquid from the pump through the inlet tube and check valve.

24. Personal water bottle comprising:
an elongated container formed with a container chamber and having an inlet on one end thereof;
a filter for filtering water passed through the inlet;
a pump housing including a communication wall interfacing the container chamber and including an outlet;
at least one inlet tube leading from the inlet to an outlet end at the end of the container opposite the one end and including a check valve for permitting flow from the inlet to the other end of the chamber;
a pump in the housing for pumping fluid from the container chamber, through the filter, to the pump chamber and then through the inlet tube to the outlet end; and
a fluid impervious divider bag mounted from the container for receiving fluid from the inlet tube and expandable upon receiving fluid from the inlet tube to distend into the container chamber.
